(19) United States
(12) Patent Application Publication
(10) Pub. No.: US 2024/0408824 A1
(43) Pub. Date: Dec. 12, 2024

(54) PETALOID FLUID DISPENSING CORE AND USE THEREOF FOR CONTROLLING THE ATMOSPHERE OF A 3D PRINTER

(71) Applicant: COMPAGNIE GENERALE DES ETABLISSEMENTS MICHELIN, Clermont-Ferrand (FR)

(72) Inventors: MICKAEL ROUBY, Clermont-Ferrand (FR); CLEMENT NAGODE, Clermont-Ferrand (FR)

(21) Appl. No.: 18/703,221

(22) PCT Filed: Oct. 14, 2022
(86) PCT No.: PCT/FR2022/051945

§ 371 Date: Apr. 19, 2024

(30) Foreign Application Priority Data
Oct. 21, 2021 (FR) FR2111180

(51) Int. Cl. B29C 64/371; B29C 64/209; B29C 64/25; B29K 71/00; B33Y 30/00; B33Y 40/00

(52) U.S. Cl. CPC B29C 64/371; B29C 64/209; B29C 64/25; B33Y 30/00; B33Y 40/00; B29K 2071/00

(57) ABSTRACT

A fluid dispensing device (100) for controlling the atmosphere of a work zone (20) has a first connection stage (103), which is provided with an intake chamber (105), intended to receive the incoming fluid (101) and an evacuation chamber (106) intended to collect the outgoing fluid (102) and separated from the intake chamber (105) by a first partitioning structure (110), then a second dispensing stage (104), which comprises, according to an alternation of injection angular segments (A111) and of extraction angular segments (A112) defined by a second partitioning structure (114), a plurality of injection cells (111) which communicate with the intake chamber (105) and which are coupled respectively to several injection points (46) provided in the work zone (20), and plurality of extraction cells (112) which communicate with the evacuation chamber (106) and which are coupled respectively to several extraction points (47) provided in the work zone (20).

The present invention relates to the field of the control of fluids, and more particularly the field of the control of gaseous fluids within an enclosure placed under a controlled atmosphere.

The present invention relates more specifically to the application of such a fluid control to the enclosure of a three-dimensional printer, within which a piece is generated by depositing, in an enclosure placed under a controlled atmosphere, a printing material in several successive layers.

It is known practice to equip manufacturing machines of an associated closed enclosure with an atmosphere control system, which makes it possible to regulate the temperature and/or the composition of the atmosphere which prevails in said enclosure.

However, the known atmosphere control devices are often bulky, and generally complex and costly.

Furthermore, when wanting to maintain a relatively homogeneous atmosphere in the enclosure, notably if it is an enclosure of small volume, it is sometimes difficult to adapt the flow of the fluid and control the dispensing as well as the impetuosity of said flow in such a way that a sufficient stirring of the atmosphere to homogenise said atmosphere is ensured without in any way disrupting the manufacturing process which is working in the enclosure.

The objects assigned to the invention consequently aim to remedy the above-mentioned drawbacks and propose a novel fluid dispensing device which is effective while being simple, robust, compact and inexpensive.

The objects assigned to the invention are achieved by means of a fluid dispensing device intended to be connected to a work zone in order to be able to inject an incoming fluid into said work zone, and extract an outgoing fluid from said work zone, said fluid dispensing device comprising, in succession, along a central axis:
i) a first connection stage, which is provided with an intake chamber, intended to receive the incoming fluid which arrives at the dispensing device intended for the work zone, and an evacuation chamber, intended to collect the outgoing fluid originating from the work zone to allow said outgoing fluid to leave the dispensing device, said intake and evacuation chambers coexisting within a first axial range which is common to said intake and evacuation chambers, while being separated from one another by a first partitioning structure,
ii) then a second dispensing stage, which comprises, on the one hand, a plurality of injection cells which all communicate with the intake chamber and which are intended to be coupled respectively to several distinct injection points provided in the work zone, and on the other hand a plurality of extraction cells which all communicate with the evacuation chamber and which are intended to be coupled respectively to several distinct extraction points provided in the work zone, the injection cells and the extraction cells coexisting within a second axial range which is common to said injection and extraction cells, and said injection cells and extraction cells being distributed alternately with one another about the central axis, in an annular zone called “implantation band” which runs along the circumference of the second stage within which said cells are separated from one another by a second partitioning structure which subdivides said implantation band into a succession of as many adjacent angular segments, which follow one another in azimuth about the central axis and which thus form an alternation of injection angular segments, each of which is occupied by an injection cell and situated facing one or more of the injection points of the work zone, and of extraction angular segments, each of which is occupied by an extraction cell and situated facing one or more of the extraction points of the work zone.

Advantageously, the fluid dispensing device according to the invention makes it possible, by means of a compact and simple arrangement, to multiply the injection points and the extraction points by which said device manages the input and the evacuation of fluid in the work zone, while regularly alternating injection zones with extraction zones, according to the spatial frequency of the angular segments delimited by the second partitioning structure, which makes it possible to ensure a good dispensing of the fluid as well as an effective but non-violent stirring of the atmosphere bathing the work zone. A homogeneous and well-controlled atmosphere is thus obtained, without in any way disturbing the objects which are located in said work zone and/or the processes of transformation which are proceeding in said work zone.

To this end, it will be noted that the fact of disposing the cells, and more particularly the injection points and the extraction points, in corolla fashion in a peripheral implantation band which surrounds the work zone, makes it possible to ensure an active stirring of the fluid all around the work zone, and therefore all around the object which is located in said work zone and that is wanted to be maintained under a controlled atmosphere, while forming a particularly extended central work zone, which corresponds to all the free space which is situated between the central axis and the injection and extraction points, and which is available to accommodate the object to be manufactured.

Moreover, the staged disposition of the dispensing device along the central axis notably makes it possible to couple the dispensing device to the work zone by the axial end of the second stage of said dispensing device, while, at the first stage, the coupling of the intake and respectively evacuation chambers to an external circuit is easily performed, by disposing the corresponding intake and evacuation nozzles in directions transversal to the central axis, such that said coupling to the external circuit is made by lateral approach, without interfering with the work zone.

Other objects, features and advantages of the invention will be revealed in more detail on reading the following description, and using the attached drawings, provided in a purely illustrative and non-limiting manner, in which:

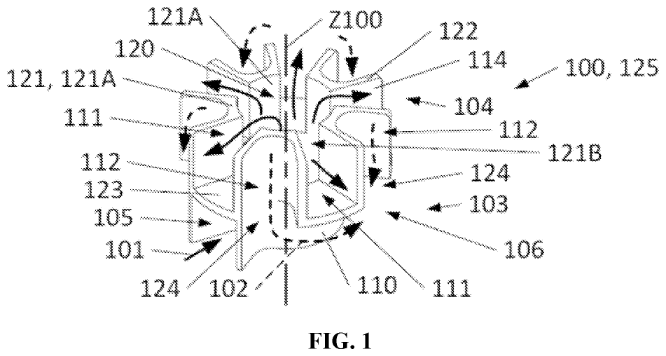

FIG. 1 illustrates, according to a perspective view, a core comprising, in a single piece, the first partitioning structure and the second partitioning structure of a fluid dispensing device according to the invention, here according to a petaloid cylindrical arrangement.

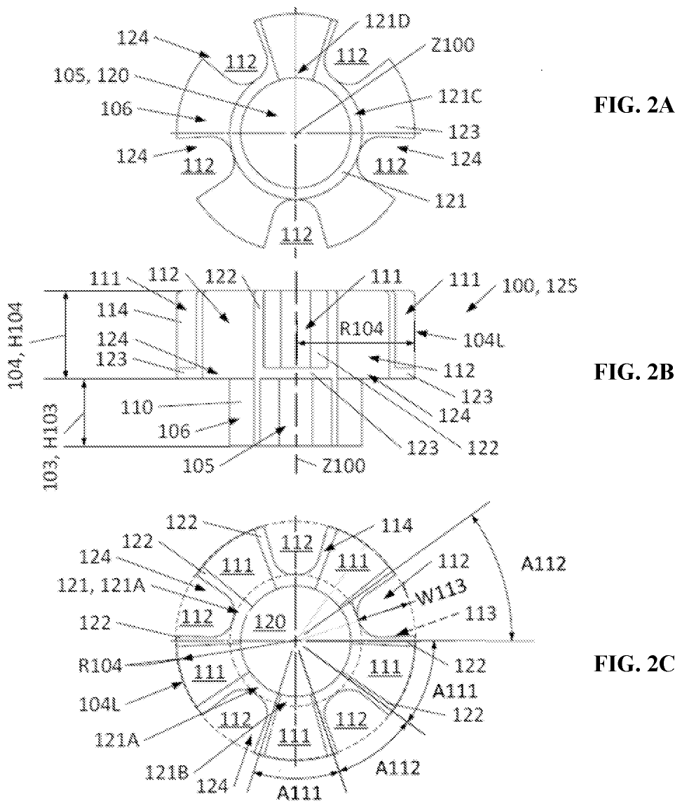

FIGS. 2A, 2B and 2C are, respectively, bottom, front and top views of the core of FIG. 1.

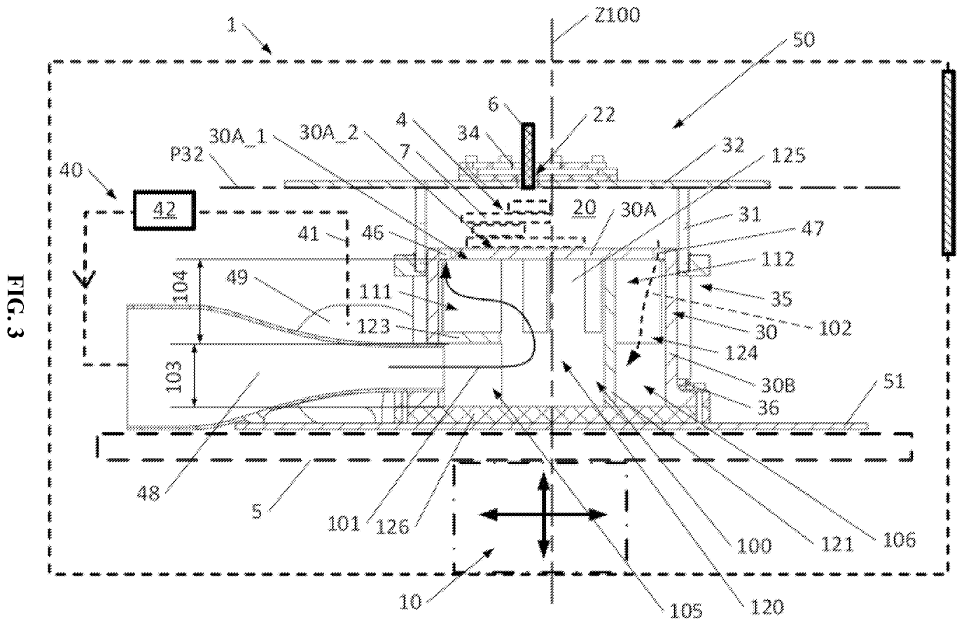

FIG. 3 represents, according to a cross-sectional view in a first radial plane containing, on the one hand, the central axis and, on the other hand, the radial axis of an intake nozzle connected to the intake chamber, a three-dimensional printing machine equipped with a module which comprises a fluid dispensing device according to the invention, which module is obtained by inserting the core of FIGS. 1, 2A, 2B, 2C in a plinth which ensures the lateral and axial partitioning of the chambers and of the cells of said core, in order to form the dispensing device, and by telescopically fitting a sliding sleeve provided with a cover over said plinth, so as to define a closed work zone which corresponds to the volume delimited by the terminal plate of the plinth, the sleeve, and the cover.

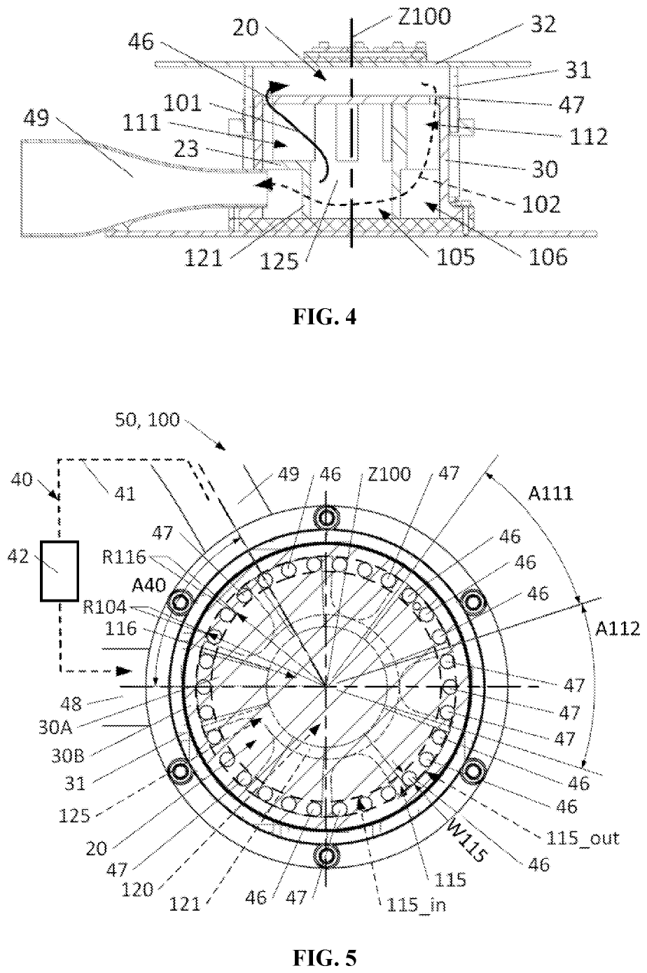

FIG. 4 represents a cross-sectional view of the module of FIG. 3, in a second radial plane which contains the central axis as well as the radial axis of an evacuation nozzle coupled to the evacuation chamber.

FIG. 5 represents the module of FIGS. 3 and 4 in a cross-sectional plane normal to the central axis, here a horizontal cross-sectional plane, and reveals, superposed, the distribution of the cells in the implantation band as well as the distribution of the injection points and the corresponding extraction points axially plumb with said cells.

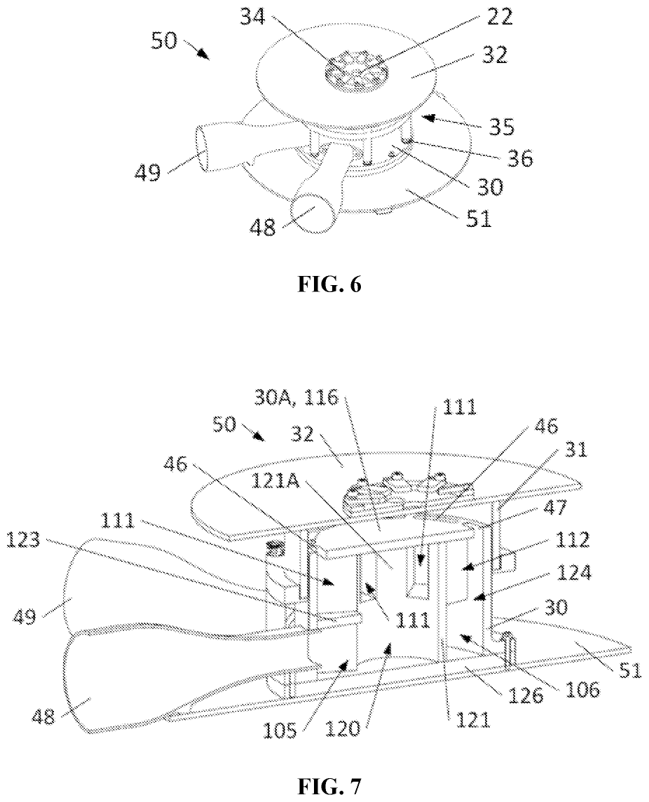

FIG. 6 is an overall perspective view of the containment module of FIGS. 3, 4 and 5.

FIG. 7 illustrates, according to a perspective view with material torn away, a variant module according to the invention which, with respect to the module of FIG. 5, has injection points and extraction points in the form of oblong grooves defining circular slits, rather than cylindrical injection points and extraction points of circular base.

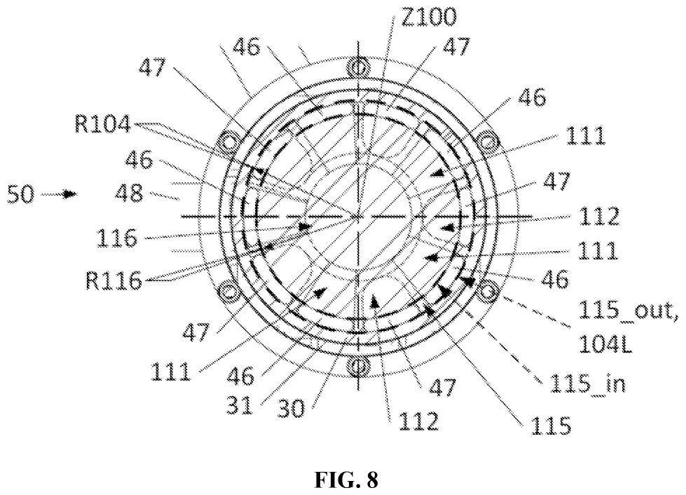

FIG. 8 is a view of the module of FIG. 7 in a cross-sectional plane normal to the central axis and according to the same conditions of representation as those used for FIG. 5.

The present invention relates to a fluid dispensing device 100 (hereinafter “dispensing device” 100) intended to be connected to a work zone 20 in order to be able to inject an incoming fluid 101 into said work zone 20, and extract an outgoing fluid 102 from said work zone 20.

In absolute terms, the outgoing fluid 102 could be distinct from the incoming fluid 101, each of said fluids forming the object of a distinct circuit.

However, preferentially, the outgoing fluid 102 is formed at least partly, even wholly, by the incoming fluid 101, after said incoming fluid 101 is passed through the work zone 20; in other words, the incoming fluid 101 forms a “new” fluid, the composition and the temperature of which correspond to those of the atmosphere desired for the work zone 20, while the outgoing fluid 102 corresponds to this same fluid once “used”, after it has passed through the work zone 20.

If necessary, the outgoing fluid 102 will be able to convey effluents to be evacuated from the work zone 20, for example particles or fumes, which will have been generated by the process working in the work zone 20.

For convenience in the description, the incoming fluid 101 and the outgoing fluid 102 will be able to be designated equally by the generic expression “the fluid” hereinbelow.

The fluid 101, 102 will be able to be a liquid, or preferably a gas, and more preferentially an inert gas, such as nitrogen gas.

The work zone 20 preferably corresponds to a closed enclosure, which is tight to the fluid 101, 102 used.

According to a particularly preferential application, the work zone 20 is a work chamber 20 of a three-dimensional printing machine 1, provided with a nozzle 6 arranged to deposit successive layers of a printing material 7, preferably a thermoplastic material, in order to generate a piece 4 in three dimensions in said work chamber 20, as is illustrated schematically in FIG. 3.

The fluid dispensing device 100 comprises, in succession, along a central axis Z100, a first connection stage 103 then a second dispensing stage 104.

The first connection stage 103 serves as coupling interface with a circuit 40 external to the dispensing device 100, an external circuit 40 which is charged with fetching the new fluid 101 and recovering the used fluid 102. The second dispensing stage 104 forms a coupling interface with the work zone 20, and serves to spatially distribute the flows of the fluid 101, 102 according to different channels which are situated facing said work zone 20, as will be detailed below.

Advantageously, the axial stacking of said first and second stages 103, 104 makes it possible to distribute the functions devolved to the dispensing device 100 in a very compact volume.

Hereinbelow, “axial” will designate a direction which is parallel to that of the central axis Z100, and “radial” will designate a direction which is at right angles to said central axis Z100.

The first stage 103, or “connection stage” 103, is provided with an intake chamber 105, which is intended to receive the incoming fluid 101 which arrives at the dispensing device 100 intended for the work zone 20, and an evacuation chamber 106, which is intended to collect the outgoing fluid 102 originating from the work zone 20 to allow said outgoing fluid 102 to leave the dispensing device 100.

To this end, the first stage 103 can receive an intake nozzle 48 coupled to the intake chamber 105 and an evacuation nozzle 49, distinct from the intake nozzle 48 and coupled to the evacuation chamber 106. Said nozzles 48, 49 preferably extend transversely to the central axis Z100, and more preferentially at right angles to the central axis Z100.

Said nozzles 48, 49 are preferably coupled to a same external circuit 40 forming a closed-circuit recirculation loop 41.

Said recirculation loop 41 advantageously makes it possible to recondition the used fluid 102, for example by reheating it and/or by filtering it, in order to be able to re-use said used fluid 102 coming from the work zone 20 as new fluid 101 reinjected into this same work zone 20.

Preferably, the recirculation loop 41 comprises a heating device 42, such as a ceramic heating tube provided with heating electric resistors, through which the fluid 101, 102, captive in the recirculation loop 41, circulates to be reheated.

In the first stage 103, the intake chamber 105 and the evacuation chamber 106 coexist within a first axial range H103 which is common to said intake 105 and evacuation 106 chambers, while being separated from one another by a first partitioning structure 110.

The fact that the two chambers 105, 106 share a same axial range H103 makes it possible to give the first stage 103 a very compact structure.

Such an arrangement notably makes it possible to position the intake 48 and evacuation 49 nozzles in this same first axial range H103, according to a transverse disposition, and preferably radial, with respect to the central axis Z100, and more particularly in two secant radial directions, which have between them, in azimuth about the central axis Z100, an aperture angle A40 that is non-zero and preferably between 60 degrees and 90 degrees, as can be seen in FIGS. 5 and 6.

Such an arrangement also allows, as will be seen hereinbelow, an optimisation of the thermal behaviour of the dispensing device 100.

Obviously, the first partitioning structure 110 is tight to the fluid 101, 102 used, within the temperature and pressure ranges in which the dispensing device 100 is used.

The second stage 104, or “dispensing stage” 104, comprises, for its part, a part of a plurality of injection cells 111 which all communicate with the intake chamber 105 and which are intended to be coupled respectively to several distinct injection points 46 provided in the work zone 20, and on the other hand a plurality of extraction cells 112 which all communicate with the evacuation chamber 106 and which are intended to be coupled respectively to several distinct extraction points 47 provided in the work zone 20. It will be noted that, here, the extraction points 47 are both distinct from one another and distinct from the injection points 46.

The injection cells 111 and the extraction cells 112 coexist within a second axial range H104 which is common to said injection 111 and extraction 112 cells, and said injection cells 111 and extraction cells 112 are distributed alternately to one another about the central axis Z100, in an annular zone 113 called “implantation band” 113, represented by dotted lines in FIG. 2C, an implantation band 113 which runs along the circumference 104L of the second stage 104 and within which said cells 111, 112 are separated from one another by a second partitioning structure 114.

As is clearly visible in FIG. 2C, said second partitioning structure 114 subdivides said implantation band 113 into a succession of as many adjacent angular segments A111, A112, that is to say as many distinct adjacent angular segments as the total number of cells 111, 112 counting the injection cells 111 and the extraction cells 112. These adjacent angular segments A111, A112 follow one another in azimuth about the central axis Z100, and thus form an alternation of injection angular segments A111, each of which is occupied by an injection cell 111 and situated facing one or more of the injection points 46 of the work zone 20, and of extraction angular segments A112, each of which is occupied by an extraction cell 112 and situated facing one or more of the extraction points 47 of the work zone 20, as can be seen in FIG. 5.

Thus, when the implantation band 113 is travelled along the circumference 104L of the second stage 4, by turning in azimuth about the central axis Z100, there are encountered, in succession, an injection angular segment A111, then an extraction angular segment A112, then once again an injection angular segment A111, then an extraction angular segment A112, and so on.

The dispensing device 100 will preferably comprise as many injection cells 111, and therefore injection angular segments A111, as extraction cells 112, and therefore extraction angular segments A112.

Preferably, the dispensing device 100 will comprise between 3 and 12 injection cells 111, more preferentially between 4 and 7 injection cells 111, for example 5 injection cells 111 as illustrated in FIGS. 2C and 5, and as many corresponding extraction cells 112.

Preferably, all the injection angular segments A111 have the same individual angular coverage, and likewise, all the extraction angular segments A112 have the same individual angular coverage, preferably equal to that of the injection angular segments A111.

Furthermore, the aggregate of the injection angular segments A111 and of the extraction angular segments A112 preferably covers all of the outline of the second stage 104, over 360 degrees about the central axis Z100.

Preferably, in projection in a plane normal to the central axis Z100, the second stage 104 exhibits an invariancy by rotation of order N, where N is the integer number of injection cells 111, equal to the integer number of extraction cells 112 (and here having the value 5, in FIGS. 1 and 5).

Preferably, the injection cells 111 do not overlap the extraction cells 112 in the circumferential direction which follows the outline 104L of the second stage, that is to say that the azimuthal coverage of the injection angular segments A111 does not intrude on the azimuthal coverage of the extraction angular segments A112.

According to one production possibility, as can be seen in FIG. 5, each injection cell 111 will service several injection points 46, for example two to four injection points 46, and more preferentially three injection points. Similarly, respectively, each extraction cell 112 will preferably service several extraction points 47, for example two to four extraction points 47, and more preferentially three extraction points 47. This will notably be able to be applied advantageously when the injection points 46, respectively the extraction points 47, are formed by cylindrical holes of circular base, as can be seen in FIG. 5.

According to another production possibility, the injection points 46, respectively the extraction points 47, will be able to be formed by oblong grooves which form slits in circular arcs, centered on the central axis Z100, as is illustrated in FIGS. 7 and 8. According to such an arrangement, each injection cell 111 will be able to service a single injection slit, and each extraction cell 112 will be able to service a single extraction slit, each slit preferably occupying in azimuth about the central axis Z100 at least half, and preferably substantially all, of the angular coverage of the angular segment A111, A112 to which said slit is assigned.

Advantageously, in all the cases, whatever the form, circular or oblong, of the injection points 46, respectively of the extraction points 47, the invention offers, on a same tower in azimuth about the central axis Z100, a multiplicity of injection points 46, fed by a multiplicity of corresponding injection cells 111, and a multiplicity of extraction points 47, connected to a multiplicity of corresponding extraction cells 112, which makes it possible to distribute the circulation of the fluid 101, 102 in as many channels, over the entire perimeter of the second stage 104, and therefore over the entire perimeter of the work zone 20, while regularly alternating between injection zones on the one hand, which correspond to the injection angular segments A111, and extraction zones on the other hand, which correspond to the extraction angular segments A112.

In the first variant corresponding to FIG. 5, each injection zone will preferably group together several successive injection points 46 (here, three injection points 46) assigned to a same injection cell 111, while each extraction zone will group together several successive extraction points 47 (here, three extraction points 47) assigned to a same extraction cell 112. In the second variant corresponding to FIGS. 7 and 8, each injection zone will preferably comprise a single injection slit, while each extraction zone will comprise a single extraction slit.

The multiplicity and the balanced distribution of the injection cells 111, respectively of the extraction cells 112, all around the central axis Z100, and therefore the corresponding multiplicity and distribution, per individual or in subgroups, of the associated injection points 46, respectively of the associated extraction points 47, advantageously guarantee the effectiveness and the homogeneity of the circulation of the fluid 101, 102 in the work zone 20.

Furthermore, the arrangement proposed by the invention makes it possible to position the injection points 46 and the extraction points 47 in a relatively narrow peripheral zone 115, close to the circumference 104L of the second stage, and more globally close to the radial limit of the work zone 20.

This makes it possible to free up a large central zone 116, available to receive the piece 4 which is currently being manufactured. Said central zone 116 corresponds in fact to the space, here the disc surface on FIG. 5, which extends from the central axis Z100 to the radially inner limit of the peripheral zone 115 which surrounds said central zone 116.

As an indication, the peripheral zone 115, within which all the injection 46 and extraction 47 points are situated, preferably has a width W115, considered radially to the central axis Z100, which is less than or equal to 30%, more preferentially less than or equal to 20%, and for example between 5% and 15%, of the distance R104 which separates the central axis Z100 of the circumference 104L from the second stage 104 in the radial direction considered. Thus, in an equivalent manner, the radial extent (or, by analogy with reference to a circular geometry, “the radius”) R116 of the central zone 116 in the radial direction considered will represent at least 70% (=100%-30% hereinabove), preferably at least 80% (=100%-20% hereinabove), and more preferentially between 85% (=100%-15% hereinabove) and 95% (=100%-5% hereinabove) of the radial extent R104 of the second stage 104 in the radial direction considered.

Preferably, in a plane normal to the central axis Z100, the plotline of the circumference 104L of the second stage 104, called “base plotline”, and therefore the plotline of the implantation band 113 and consequently the respective plotlines of the radial limits of the work zone 20, of the peripheral zone 115 and of the central zone 116 fitted non-concentrically to one another, will have a circular form, centered on the central axis Z100.

Obviously, it is perfectly possible to envisage, in a variant, the plotlines having polygonal forms, preferably identical in their form from one plotline to the other, such as, for example, rectangular, square, hexagonal, decagonal or other forms, and notably regular polygonal forms, which would have, for example, as many sides, equal, as the dispensing device 100 has cells 111, 112 in all.

Preferably, as is clearly visible in FIGS. 1, 2A, 2C and 3, the intake chamber 105 forms a central well 120 which extends from the first stage 103 to the second stage 104 and which is delimited, about the central axis Z100, by a lateral wall 121 which, at the first stage 103, forms a part of the first partitioning structure 110 separating the intake chamber 105 from the evacuation chamber 106, and, at the second stage 104, forms a part of the second partitioning structure 114.

Preferably, at the second stage 104, said lateral wall 121 of said central well 120 opens onto each of the injection angular segments All in order to supply incoming fluid 101 to each of the injection cells 111, which are distributed in star-fashion around said central well 121.

Advantageously, it is thus possible to simply and effectively convey the incoming fluid 101 from the first stage 103 to the second stage 104, according to an axial flow, by means of one and the same central channel formed by the central well 120, then distribute said incoming fluid 101 from said central channel to the different injection cells 111, which form a branching of said central channel into several peripheral channels, by redirecting the fluid according to as many centrifugal radial flows.

At the second stage 104, the lateral wall 121 of the central well 120 preferably has an overall cylindrical form which extends axially over the entire second axial range H104 and of which the generatrices are parallel to the central axis Z100.

At said second stage 104, said lateral wall 121 alternates on the one hand solid portions 121A, which mask the extraction angular segments A112 in order to separate the central well 120 from the extraction cells 112, with, on the other hand, portions of interruption 121B, which extend over the injection angular segments A111 to form as many apertures through which the central well 120 can pour the incoming fluid 101 into the injection cells 111.

For ease of production and to maximise the cross-section of the channels duly formed in order to guarantee the effectiveness of the transfers of incoming fluid 101, the portions of interruption 121B are preferably empty axially over at least 75%, preferably over at least 80%, or even substantially over all of the second axial range H104, and therefore, here, over the entire axial height of the injection cells 111, and circumferentially over the entire angle covered in azimuth about the central axis Z100 by the injection angular segment A111 considered.

At the first stage 103, the lateral wall 121 has a solid portion 121C which preferably covers, in azimuth about the central axis Z100, an angular segment which corresponds to, and which, in projection in a plane normal to the central axis Z100 is superposed with, the aggregate extent of all of the injection A111 and extraction A112 angular segments of the second stage 104, except for a single injection angular segment A111, axially plumb with which is situated a portion of interruption 121D, the purpose of which is to connect the intake chamber 105 with the intake nozzle 48.

Here again, said solid 121C and interruption 121D portions extend advantageously over the entire first axial range H103, and therefore over the entire axial height of the intake chamber 105.

Advantageously, the intake chamber 105 can thus occupy a central position with respect to the central axis Z100, protected from the outside of the dispensing device 100 by the evacuation chamber 106, which is peripheral, which surrounds said intake chamber 105 over a significant portion of the circumference of said intake chamber 105 about the central axis Z100.

Such an arrangement is notably particularly advantageous from a thermal point of view, when using an incoming fluid 101 having an incoming temperature which is different from, for example greater than, the ambient temperature which prevails outside of the dispensing device 100, and, in the evacuation chamber 106, an outgoing fluid 102 is collected which has an intermediate temperature between the incoming temperature and the ambient temperature. Indeed, the evacuation chamber 106 then acts as a peripheral buffer zone which protects the central intake chamber 105 from the heat transfers with the outside. In the example more specifically chosen, the presence of the “tepid” evacuation chamber 106 thus delimits the heat losses of the “hot” intake chamber 105 to the “cold” outside.

Preferably, at the first stage 103, the evacuation chamber 106 can surround the intake chamber 105 over at least 180 degrees, even at least 270 degrees, about the central axis Z100.

As an indication, this coverage about the central axis Z100 will be able to be between 180 degrees and 330 degrees.

As can clearly be seen in FIGS. 1 and 2C, at the second stage 104, the second partitioning structure 114 comprises, in addition to the solid portions 121A of the lateral wall 121 of the central well 120, radial partitions 122 which each form a shared partition between an injection cell 111 and an adjacent extraction cell 112. Thus, each radial partition 122 embodies the limit between an injection angular segment A111 and the extraction angular segment A112 which immediately precedes or follows said injection angular segment A111.

Each radial partition 122 preferably extends solidly and continuously over the entire radial width W113 of the implantation band 113, and, in height, over the entire second axial range H104.

Moreover, the second partitioning structure 114 preferably comprises, as can be seen notably in FIGS. 1, 3 and 4, a floor 123 which marks the limit between the first stage 103 and the second stage 104.

This floor 123 preferably extends parallel to a plane normal to the central axis Z100.

The floor 123 thus advantageously separates the injection cells 111, and, respectively, extraction cells 112, on the one hand which extend on one side, here above, of said floor 123, from the intake 105, respectively evacuation 106, chambers on the other hand, which extend on the other side of said floor 123.

At the first stage 103, the evacuation chamber 106 preferably extends around the central well 120, axially plumb with the implantation band 113 of the injection cells 111 and of the extraction cells 112 of the second stage 104, and over an azimuthal extent about the central axis Z100 which allows said evacuation chamber 106 to cover all the extraction angular segments A112, with which said evacuation chamber 106 communicates by means of cutouts 124 which are formed in the floor 123 in each of the extraction angular segments A112.

In other words, the floor 123 is preferably interrupted in the extraction angular segments A112, by the cutouts 124, so as to directly connect the extraction cells 112 with the underlying evacuation chamber 106, which makes it possible to ensure an effective collection and evacuation of the outgoing fluid 102, by means of a compact structure.

The device 100 thus has in fact an evacuation manifold within which the multiple axial extraction channels formed by the extraction cells 112 meet to form a single main channel, which covers, about the central axis Z100, a portion of ring corresponding to the evacuation chamber 106.

Preferably, for ease of manufacture and to maximise the cross-section of the duly formed channels, the cutouts 124 extend over the entire surface of the floor 123 which is included between the two successive radial partitions 122 and the solid portion 121A of the lateral wall 121 of the central well 120, which delimit the extraction angular segment A112 considered, as can clearly be seen in FIG. 1.

According to a particularly preferential feature, the first partitioning structure 110 and the second partitioning structure 114 are formed in a single piece with one another.

A particularly simple and robust structure is thus obtained, which groups together, in a single piece, the floor 123, the lateral wall 121 of the central well 120 which passes through said floor 123 and extends axially on either side of said floor, and the radial partitions 122 which delimit the angular segments A111, A112 assigned to the different cells 111, 112.

Such a piece will be able to be produced in steel, in an aluminium alloy, in ceramic, or in a plastic resistant to the service temperatures of the device 100, for example made of PEEK (poly-ether-ether-ketone). It will be noted that it may be advantageous to use a material, notably a plastic, called “thermally insulating” plastic, in that said material exhibits a thermal conductivity that is lower than that of steel or aluminium, the purpose of this being to limit the heat transfers between the intake chamber 105 and the evacuation chamber 106, and, more globally, between the incoming fluid 101 and the outgoing fluid 102. Whatever the constituent material, such a piece made of a single piece will be able to be obtained for example by moulding or by machining.

According to a preferential production possibility, the fluid dispensing device 100 comprises a core 125 which comprises, preferably in a single piece as indicated hereinabove, the first partitioning structure 110 and the second partitioning structure 114.

Preferably, notably for ease of manufacture, the cells 111, 112 of said core 125 open on the circumference 104L of the second stage 104, that is to say on the radially outer limit of the core 125, and preferably form, given the direction of opening of the corresponding angular segments A111, A112, cells that are concave with respect to the central axis Z100.

For ease of manufacture and assembly, the core 125 will advantageously be able to be inscribed in a tapered form of circular base and centered on the central axis Z100, or, more preferentially, in a straight cylindrical form of circular base and centered on the central axis Z100.

Advantageously, the core 125 is inserted into a hollow plinth 30 which comprises, on the one hand, a stock 30B which cooperates tightly with the core 125 in order to form, all about the central axis Z100, a lateral wall which marks the radially outer limit of the intake 105 and evacuation 106 chambers of the first stage 103, and of the injection 111 and extraction 112 cells of the second stage 104, and, on the other hand, a terminal plate 30A, normal to the central axis Z100, a first face 30A_1 of which cooperates in tight contact with the axial end of the second partitioning structure 114 which is situated axially opposite the first stage 103, so as to form the axial limit of the injection 111 and extraction 112 cells, and a second face 30A_2 of which, axially opposite, forms a wall of the work zone 20, preferably a horizontal reception face on which the piece 4 currently being manufactured will rest.

The plinth 30 therefore covers the core 125 so as to complement the partitioning structures 110, 114 to close the contours of the cross-sections of the channels formed by the cells 111, 112 and the chambers 105, 106.

The axial end of the core 125 situated on the side of the first stage 103, and therefore the base of the chambers 105, 106, can advantageously be tightly blocked by a stopper 126, here formed by a disc normal to the central axis Z100, which closes the base of the plinth 30.

Advantageously, the modular structure thus proposed simplifies the assembly of the device 100 as well as the dismantling thereof for cleaning.

Preferably, the terminal plate 30A has, facing the cells 111, 112, a plurality of holes which pass axially through said terminal plate from the first face 30A_1 to the second face 30A_2 in order to form, on the second face 30A_2, the injection points 46 and the extraction points 47 of the work zone 20.

Thus, a rapid and effective transfer of the fluid 101, 102 is ensured between the device 100 and the work zone 20, by means of a very simple arrangement of the device 100.

As indicated above, these holes can take the form of cylindrical holes of circular base, or even, to maximise the cross-section of the injection channels, respectively of the extraction channels, for a given surface area of the central zone 116, take the form of oblong and arched grooves forming slits in circular arc form.

Preferably, the injection points 46 and the extraction points 47 of the work zone 20 are situated in a peripheral zone 115 of the terminal plate 30A which is included, in projection in a plane normal to the central axis Z100, between a radially outer limit 115_out which corresponds to the lateral edge of the core 125, considered in a direction radial to the central axis Z100, and a radially inner limit 115_in situated at a distance, considered in the same radial direction, which is equal to or greater than 70%, preferably equal to or greater than 80%, and for example between 85% and 95%, of the distance, here R104, which separates said lateral edge of the core 125 from said central axis Z100.

The peripheral zone 115 will thus correspond to a peripheral annular band whose width W115 represents, as indicated above, less than 30%, preferably less than 20%, and more preferentially between 5% and 15% of the distance R104 which radially separates the central axis Z100 from the circumference 104L of the second stage 104.

The terminal plate 30A will thus offer a large solid central zone 116 for receiving the piece 4 currently being manufactured.

It will be noted that, preferably, the peripheral zone 115 is, in projection in a plane normal to the central axis Z100, contained in the underlying implantation band 113, which has a width W113 equal to or greater than the width W115 of the peripheral zone, notably in order to ensure the radial transfer, via the injection cells 111, of the incoming fluid 101 from the central well 120 to the holes forming the injection points 46.

Preferably, all the holes forming the injection points 46 have the same diameter. Likewise, all the holes forming the extraction points 47 preferably have the same diameter, preferentially equal to the diameter of the holes forming the injection points 46. Likewise, if slits in circular arc form are used to form the injection points 46, respectively the extraction points 47, said slits will preferably all have the same radial width. As an indication, the diameter of said holes, respectively the radial width of the slits, and therefore more globally the radial width of the injection points 46, respectively of the extraction points 47, preferably represents between 3% and 10% of the overall diameter of the core 125, which makes it possible to limit the width W115 of the peripheral zone 115, and therefore to maximise the radial extent of the central zone 116.

Furthermore, preferably, the injection points 46 and the extraction points 47 are preferably situated all at the same radial distance from the lateral edge of the core 125, and, consequently, in the case of a circular arrangement of the core 125, are all situated at the same distance from the central axis Z100. The distance considered is, for example here, the distance from the centre of the holes to the central axis Z100 for circular holes, or the distance from the centre line of the oblong grooves to the central axis Z100 in the case of slits in circular arc form.

The invention relates also to a containment module 50 intended to delimit a work zone 20 and to place said work zone 20 under a controlled atmosphere.

Said module 50 comprises a fluid dispensing device 100 as described hereinabove, as well as a sleeve 31 which forms a closed ring about the central axis Z100 and which extends axially protruding from the terminal plate 30A of the plinth 30, as well as a cover 32 which closes the sleeve 31 axially opposite the terminal plate 30A of the plinth, so as to form a closed cavity which is delimited by the sleeve 31, by the cover 32 and by the terminal plate 30A of the plinth and which forms the work zone 20.

The sleeve 31 thus forms a lateral wall which radially delimits the cavity forming the work zone 20, while the cover 32 and terminal plate 30A form the end walls which axially limit said cavity forming the work zone 20.

Preferably, the central axis Z100 is vertical, such that the terminal plate 30A forms the horizontal bottom of the cavity, which supports the piece 4 during the manufacture thereof.

Advantageously, the atmosphere of the work zone 20 is controllable, and therefore advantageously controlled during the use of the module 50, by creating, in the above-mentioned cavity, a circulation of a gaseous fluid 101, 102 which is injected into said cavity through the injection points 46 provided in the plinth 30 then evacuated from said cavity through the extraction points 47 provided in the plinth 30.

It will be noted to this end that the injection 46 and extraction 47 points are located in practice close to the wall of the sleeve 31, such that the movements of fluid 101, 102 which generate the stirring of the atmosphere are also located along the wall of the sleeve 31, and more preferentially oriented axially at the output of the injection points 46 and at the input of the extraction points 47, such that these movements of fluid 101, 102 do not disrupt the activities which take place in the central zone 116 of the terminal plate 30A, where the piece 4 currently being manufactured is typically located.

Preferably, the sleeve 31 is fitted over the stock 30 of the module 50 and mounted to slide with respect to said stock 30 along the central axis Z100, so as to be able to protrude axially with respect to the terminal plate 30A telescopically.

Advantageously, such a telescopic structure 35 makes it possible to adapt the size of the cavity forming the work zone 20, and more particularly adapt the height of said cavity, that is to say the distance which axially separates the terminal plate 30A from the cover 32, while retaining the seal-tightness obtained by the sleeve 31, as the terminal plate 30A is lowered vertically to accompany the stack of the layers of the printing material 7.

The sleeve 31 is preferably pressed axially tightly against the cover 32 by one or more return springs 36.

The invention relates finally as such to a three-dimensional printing machine 1 which comprises a work zone 20, an injection nozzle 6 for depositing a printing material 7 in successive layers in said work zone 20 to manufacture a piece 4, and a fluid dispensing device 100 according to any one of the above features for controlling the atmosphere of said work zone 20.

More preferentially, the invention relates to a three-dimensional printing machine 1 which, as can be seen in FIG. 3, comprises a containment module 50 as described above, as well as an injection nozzle 6 which passes through the cover 32 of the module 50 through an insertion orifice 22 provided for this purpose in said cover 32, and which is arranged to deposit a printing material 7 in successive layers in the cavity of the module 50 forming the work zone 20 in order to generate a piece 4 in said cavity.

The central axis Z100 of the module 50 here corresponds preferably to the vertical axis of the machine 1.

The module 50 can advantageously be fixed by means of a base 51 onto a main plate 5 of the machine 1, which main plate 5 is movable vertically and horizontally and placed under the control of a drive system 10 which makes it possible to create a relative movement of the main plate 5, and therefore of the work zone 20, with respect to the nozzle 6, in order to draw the form of the piece 4.

The cover 32 preferably rests to bear slidingly against the top rim of the sleeve 31, in a horizontal plane P32, in order to accommodate the horizontal displacements of the main plate 5. The nozzle 6 is, for its part, fixed to said cover by a flange mechanism 34.

Obviously, the invention is in no way limited to only the variant productions set out in the above, the person skilled in the art being notably able to isolate or freely combine together one or other of the abovementioned features, or substitute equivalents for them.

1-10. (canceled)

11. A fluid dispensing device (100) configured to be connected to a work zone (20) in order to be able to inject an incoming fluid (101) into the work zone (20) and extract an outgoing fluid (102) from the work zone (20), the fluid dispensing device comprising, in succession along a central axis (Z100):
(i) a first connection stage (103), which is provided with an intake chamber (105), configured to receive the incoming fluid (101) which arrives at the fluid dispensing device (100), and an evacuation chamber (106), configured to collect the outgoing fluid (102) originating from the work zone (20) to allow the outgoing fluid (102) to leave the fluid dispensing device (100), the intake chamber (105) and the evacuation chamber (106) coexisting within a first axial range (H103) which is common to the intake chamber (105) and the evacuation chamber (106), while being separated from one another by a first partitioning structure (110); and
(ii) then a second dispensing stage (104), which comprises a plurality of injection cells (111), which communicate with the intake chamber (105) and which are intended to be coupled respectively to several distinct injection points (46) provided in the work zone (20), and a plurality of extraction cells (112), which communicate with the evacuation chamber (106) and which are intended to be coupled respectively to several distinct extraction points (47) provided in the work zone, the injection cells (111) and the extraction cells (112) coexisting in a second axial range (H104) which is common to the injection cells (111) and extraction cells (112), and the injection cells (111) and extraction cells (112) being distributed alternately with one another about the central axis (Z100), in an implantation band (113) which runs along a circumference (104L) of the second dispensing stage (104) and within which the injection cells (111) and extraction cells (112) are separated from one another by a second partitioning structure (114) which subdivides the implantation band (113) into a succession of as many adjacent angular segments (A111, A112), which follow one another in azimuth about the central axis (Z100) and which form an alternation of injection angular segments (A111), each of which is occupied by an injection cell (111) and situated facing one or more of the injection points (46) of the work zone (20), and of extraction angular segments (A112), each of which is occupied by an extraction cell (112) and situated facing one or more of the extraction points (47) of the work zone (20).

12. The fluid dispensing device according to claim 11, wherein the first partitioning structure (110) and the second partitioning structure (114) are formed in a single piece with one another.

13. The fluid dispensing device according to claim 11, wherein the intake chamber (105) forms a central well (120) which extends from the first connection stage (103) to the second dispensing stage (104) and which is delimited, about the central axis (Z100), by a lateral wall (121) which, at the first connection stage (103), forms a part of the first partitioning structure (110) separating the intake chamber (105) from the evacuation chamber (106), and, at the second dispensing stage (104), forms a part of the second partitioning structure (114), and
wherein, at the second dispensing stage (104), the lateral wall (121) of the central well (120) opens onto each of the injection angular segments (A111) in order to supply incoming fluid (101) to each of the injection cells (111), which are distributed in star-fashion around the central well (120).

14. The fluid dispensing device according to claim 13, wherein the second partitioning structure (114) comprises a floor (123) which marks a limit between the first connection stage (103) and the second dispensing stage (104), and
wherein, at the first connection stage (103), the evacuation chamber (106) extends around the central well (120), axially plumb with the implantation band (113) of the injection cells (111) and of the extraction cells (112) of the second dispensing stage (104), and over an azimuthal extent about the central axis (Z100) which allows the evacuation chamber (106) to cover all the extraction angular segments (A112), with which the evacuation chamber (106) communicates by means of cutouts (124) which are formed in the floor (123) in each of the extraction angular segments (A112).

15. The fluid dispensing device according to claim 11, wherein, at the first connection stage (103), the evacuation chamber (106) surrounds the intake chamber (105) over at least 180 degrees about the central axis (Z100).

16. The fluid dispensing device according to claim 11 further comprising a core (125) comprising the first partitioning structure (110) and the second partitioning structure (114),
wherein the core is inserted into a hollow plinth (30) which comprises a stock (30B) which cooperates tightly with the core (125) in order to form, all about the central axis (Z100), a lateral wall which marks a radially outer limit of the intake chamber (105) and the evacuation chamber (106) of the first connection stage (103), and injection cells (111) and extraction cells (112) of the second dispensing stage (104), and a terminal plate (30A), normal to the central axis (Z100), of which a first face (30A_1) cooperates in tight contact with an axial end of the second partitioning structure (114) which is situated axially opposite the first connection stage (103), so as to form an axial limit of the injection cells (111) and extraction cells (112), and of which a second face (30A_2), axially opposite, forms a wall of the work zone (20), the terminal plate (30A) having, facing the injection cells (111) and extraction cells (112), a plurality of holes which pass axially through the terminal plate (30A) from the first face (30A_1) to the second face (30A_2) in order to form, on the second face (30A_2), the injection points (46) and the extraction points (47) of the work zone (20).

17. The fluid dispensing device according to claim 16, wherein the injection points (46) and the extraction points (47) of the work zone (20) are situated in a peripheral zone (115) of the terminal plate (30A) which is included, in projection in a plane normal to the central axis (Z100), between a radially outer limit (115_out) which corresponds to a lateral edge of the core (125), in a direction radial to the central axis (Z100), and a radially inner limit (115_in) situated at a distance, in a same radial direction, which is equal to or greater than 70% of the distance (R104) which separates the lateral edge of the core (125) from the central axis (Z100).

18. A containment module (50) configured to delimit a work zone (20) and to place the work zone in a controlled atmosphere, the containment module (50) comprising:
the fluid dispensing device (100) according to claim 16;
a sleeve (31) which forms a closed ring about the central axis (Z100) and which extends axially protruding from the terminal plate (30A) of the plinth (30); and
a cover (32) which closes the sleeve (31) axially opposite the terminal plate (30A) of the plinth, so as to form a closed cavity which is delimited by the sleeve (31), by the cover (32) and by the terminal plate (30A) of the plinth and which forms the work zone (20), an atmosphere of which is controlled by creating in the cavity a circulation of a gaseous fluid (101, 102) which is injected into the cavity by the injection points (46) provided in the plinth (30) then evacuated from the cavity by the extraction points (47) provided in the plinth (30).

19. The containment module (50) according to claim 18, wherein the sleeve (31) is fitted onto the stock (30B) of the containment module (50) and mounted to slide with respect to the stock (30B) along the central axis (Z100), so as to be able to protrude axially with respect to the terminal plate (30A) telescopically.

20. A three-dimensional printing machine (1) comprising:
the containment module (50) according to claim 18; and
an injection nozzle (6) which passes through the cover (32) of the module through an insertion orifice (22) provided in the cover (32), and which is arranged to deposit a printing material (7) in successive layers in the cavity of the module forming the work zone (20) in order to generate a piece (4) in the cavity.
